(19) United States
(12) Patent Application Publication
(10) Pub. No.: US 2014/0265997 A1
(43) Pub. Date: Sep. 18, 2014

(54) UNDERHOOD HEAT ABSORBER

(71) Applicant: GM GLOBAL TECHNOLOGY OPERATIONS LLC, Detroit, MI (US)

(72) Inventor: David J. Schmidt, Troy, MI (US)

(73) Assignee: GM GLOBAL TECHNOLOGY OPERATIONS LLC, Detroit, MI (US)

(21) Appl. No.: 13/840,230

(22) Filed: Mar. 15, 2013

(51) Int. Cl. H02N 11/00; H02J 7/00

(52) U.S. Cl. CPC H02N 11/002; H02J 7/0052
USPC 320/101; 310/306

(57) ABSTRACT

One variation may include a vehicle underhood heat absorber comprising at least one electrically conductive heat absorbing layer constructed and arranged to be connected to a vehicle battery to recharge the battery.

### TECHNICAL FIELD

The field to which the disclosure generally relates to includes a vehicle underhood heat absorber including at least one electrically conductive heat absorbing layer constructed and arranged to be connected to a vehicle battery to recharge the same, and methods of using the same.

### BACKGROUND

Vehicles having combustion engines generate heat.

### SUMMARY OF ILLUSTRATIVE VARIATIONS OF THE INVENTION

One variation may include a product including a vehicle underhood heat absorber including at least one electrically conductive heat absorbing layer constructed and arranged to be connected to a vehicle battery to recharge the battery.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a product including at least one electrically conductive heat absorbing layer for use under a vehicle engine compartment hood according to a number of variations of the invention.

FIG. 2 illustrates a product as shown in FIG. 1 and further including a underhood heat absorbing blanket overlying the at least one electrically conductive heat absorbing layer according to a number of variations of the invention.

FIG. 3 illustrates a product including at least one electrically conductive heat absorbing layer overlying an underhood heat absorbing thermal blanket according to a number of variations of the invention.

FIG. 4 is a schematic illustration of a product including first and second electrically conducting heat absorbing layers and an underhood heat absorbing blanket sandwiched there between, an electronic control unit, battery recharging components and a battery according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

Referring now to FIG. 1, a number of variations of the invention may include a product 10 which may include a first electrically conductive heat absorbing layer 12 constructed and arranged to be positioned overlying the combustion engine compartment of a vehicle and underlying the engine compartment hood 12 of such a vehicle. The first electrically conducting heat absorbing layer 12 may be operatively connected to a battery 14 to charge the battery. The first electrically conductive heat absorbing layer 12 may be positioned to capture heat generated by the vehicle combustion engine and/or heat transmitted through the vehicle hood 14, which has been heated from exposure to the sun. The first electrically conductive heat absorbing layer 12 may take on a variety of configurations including, but not limited to, a grid structure including a plurality of vertical lines 11 of electrically conductive heat absorbing material and/or a plurality of horizontal lines 13 of electrically conductive heat absorbing material. In a number of other variations the first electrically conductive heat absorbing layer 12 may be a sheet of electrically conductive heat absorbing material. In a number of variations of the invention the sheet may have one or more slots formed therein. Heat from the combustion engine compartment, or radiated or transferred through the vehicle hood 14 causes current to flow in the electrically conductive heat absorbing layer 12, which may be channeled to a battery 14 to recharge the same. In one variation of the invention a multiferroic alloy may be utilized to convert heat directly into electricity. In one variation the first electrically conductive heat absorbing layer 12 may include Ni₄₅Co₅Mn₄OSn₁₀.

FIG. 2 illustrates a product 10 as shown in FIG. 1 and further includes a underhood heat absorbing blanket 18 overlying the at least one electrically conductive heat absorbing layer 12 according to a number of variations of the invention.

FIG. 3 illustrates a product 10 including at least one electrically conductive heat absorbing layer 20 overlying an underhood heat absorbing thermal blanket 18 according to a number of variations of the invention. In a number of variations of the invention the at least one electrically conductive heat absorbing layer may include a first electrically conductive heat absorbing layer 12 and a second electrically conductive heat absorbing layer 20. A number of variations of the invention the under hood heat absorbing thermal blanket 18 may be sandwiched between the first electrically conductive heat absorbing layer 12 and the second electrically conductive heat absorbing layer 20.

FIG. 4 is a schematic illustration of a product 10 including first and second electrically conducting heat absorbing layers 12, 20 and an underhood heat absorbing blanket 18 sandwiched there between, an electronic controller system 26, battery recharging components 32, 34 and a battery 16 according to a number of variations of the invention. The first electrically conductive heat absorbing layer 12 may be positioned to be heated by heat transferred from the vehicle combustion engine compartment hood 14. A first sensor 22 may be operatively connected to the first electrically conductive heat absorbing layer 12 to measure any of a variety of properties or conditions of the layer 12 including the temperature and/or electrical current flowing therein. A second sensor 24 may be operatively connected to the second electrically conductive heat absorbing layer 22 to also measure any of a variety of properties or conditions of the layer 20 including the temperature and/or electrical current flowing therein. One or more sensors or components (not shown) may be provided to determine the state of charge of the battery.

Each of the first electrically conductive heat absorbing layers 12, may be connected to a positive terminal 28 of the battery 16, and similarly may also be connected to the negative terminal 30 of the battery 16. A plurality of battery recharging components such as, but not limited to a DC/DC converter and/or a voltage regulator 34 may be provided in a line from the electrically conductive heat absorbing layers 12, 20 and one of the positive terminal 28 or negative terminal 30 of the battery 16. The electronic control module 30 may be operatively connected to the sensors 22, 34, battery recharging components 32, 34 and the battery 16 to selectively control the recharging of the battery by current from either of or both of first and second electrically conductive heat absorbing layers 12, 20.

The controller system 26 may include a main controller and/or a control subsystem that may include one or more controllers (not separately shown) in communication with the battery 16 and sensors 22, 24 or other sensors for receiving and processing sensor input and transmitting output signals to control components or the charging of the battery. The controller(s) may include one or more suitable processors and memory devices (not separately shown). The memory may be configured to provide storage of data and instructions that provide at least some of the functionality of the engine system and that may be executed by the processor(s). At least portions of the method may be enabled by one or more computer programs and various engine system data or instructions stored in memory as look-up tables, formulas, algorithms, maps, models, or the like. The control subsystem may battery system parameters and electrical conductive heat absorbing layer parameters by receiving input signals from the sensors, executing instructions or algorithms in light of sensor input signals, and transmitting suitable output signals to the various actuators. As used herein, the term “model” may include any construct that represents something using variables, such as a look up table, map, formula, algorithm and/or the like. Models may be application specific and particular to the exact design and performance specifications of any given battery system.

The above description of select examples of the invention is merely illustrative in nature and, thus, variations or variants thereof are not to be regarded as a departure from the spirit and scope of the invention.

1. A product comprising:
a vehicle underhood heat absorber comprising at least one electrically conductive heat absorbing layer constructed and arranged to be connected to a vehicle battery to recharge the battery.

2. A product as set forth in claim 1 wherein the at least one electrically conductive heat absorbing layer comprises a grid comprising at least one of a plurality of vertical lines or a plurality of horizontal lines, wherein each of the plurality of vertical lines and plurality of horizontal lines comprise an electrically conductive heat absorbing material.

3. A product as set forth in claim 1 wherein the at least one electrically conductive heat absorbing layer is positioned over a vehicle combustion engine compartment.

4. A product as set forth in claim 1 wherein the at least one electrically conductive heat absorbing layer is positioned adjacent a vehicle engine compartment hood.

5. A product as set forth in claim 1 wherein the at least one electrically conductive heat absorbing layer comprises a first electrically conductive heat absorbing layer positioned adjacent a vehicle engine compartment hood and a second electrically conductive heat absorbing layer positioned over a combustion engine compartment of a vehicle.

6. A product as set forth in claim 5 further comprising a thermal absorbing blanket interposed between the first electrically conductive heat absorbing layer and the second electrically conductive heat absorbing layer.

7. A product as set forth in claim 1 further comprising a battery operatively connected to the at least one electrically conductive heat absorbing layer so that current flowing in the at least one electrically conductive heat absorbing layer recharges the battery.

8. A product as set forth in claim 7 further comprising electronic control unit constructed and arranged to control the recharging of the battery.

9. A product as set forth in claim 1 wherein the at least one electrically conductive heat absorbing layer comprises Ni₄₅Co₅Mn₄OSn₁₀.

10. A product as set forth in claim 1 wherein the at least one electrically conductive absorbing layer comprises a first electrically conductive heat absorbing layer and a second electrically conductive heat absorbing layer.
